(19) United States
(12) Patent Application Publication
(10) Pub. No.: US 2025/0378058 A1
(43) Pub. Date: Dec. 11, 2025

(54) METADATA-DRIVEN ANALYTICAL DATA MODELING

(71) Applicant: HEWLETT PACKARD ENTERPRISE DEVELOPMENT LP, Spring, TX (US)

(72) Inventors: Madhumita Bharde, Andover, MA (US); Agam Jain, Bangalore (IN); Devendra Kumar, Bangalore (IN)

(21) Appl. No.: 18/899,917

(22) Filed: Sep. 27, 2024

(30) Foreign Application Priority Data
Jun. 7, 2024 (IN) 202441044322

(51) Int. Cl. G06F 16/22; G06F 11/34; G06F 16/242; G06F 16/2458; G06F 16/25

(52) U.S. Cl. CPC G06F 16/2282; G06F 11/3409; G06F 16/244; G06F 16/2462; G06F 16/254

(57) ABSTRACT

Systems and methods are provided for transforming data stored in an operational database to a format/structure optimized for use in a data lakehouse. The data transformation is metadata-driven, where the metadata characterizing the transformation of data may be automatically generated via the performance of various denormalization/modeling techniques, including: path/edge/tree/log denormalization, and state machine/aggregate/adaptive modeling.

### BACKGROUND

A data model can refer to a representation of an enterprise's data elements, and the relationship(s) between such data elements. In other words, a data model can determine how data can be exposed or presented to an interested user. Data modeling then, can refer to optimally generating or structuring database tables for the purpose of facilitating data analysis, i.e., presenting the most relevant data to the interested user to answer questions regarding whatever the data may represent or characterize.

Operational systems can refer to systems that are used to maintain records of business transactions in an organization. Business transactions can encompass a variety of transactions, e.g., payroll, inventory, ordering, etc. Operational systems typically use some form of relational database management system to manage their data. Such relational database management systems are geared towards transactional workloads, e.g., relatively low-volume (touching fewer rows of a database table) read/write operations with known transaction patterns. Data warehouses, another type of database management system, are geared towards high-volume scanning of data related to analytics that can provide insights into a business. For example, a data scientist may wish to understand trends in customer subscription behavior, with a focus on ad hoc queries to gain insight into structured data. An enterprise may leverage both operational databases to conduct typical transactions (adding/removing a customer) and data warehouses to analytics (the aforementioned subscription trend analysis). In more recent times, another type of data management system referred to as a data lake has come into prominence. In contrast to data warehouses, data lakes tend to be more supportive of artificial intelligence (AI)-oriented insight (versus the business intelligence (BI) typically supported by the data warehouses), with data storage being more unstructured/semi-structured.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of operational, data transformation, and analytical systems in which examples of the disclosed technology comprising metadata-driven data modeling may be implemented.

FIG. 2 illustrates an example of a data structure and tables that may be transformed in accordance with examples of the disclosed technology.

FIG. 3 illustrates an example of metadata-driven state machine modeling in accordance with examples of the disclosed technology.

FIG. 4 illustrates example components and functionality of a lakehouse leveraged by examples of the disclosed technology.

FIG. 5 is an example computing component that may execute instructions to perform metadata-driving data transformation in accordance with examples of the disclosed technology.

FIG. 6 is an example computing component that may be used to implement various features of examples of the disclosed technology.

The figures are not exhaustive and do not limit the present disclosure to the precise form disclosed.

### DETAILED DESCRIPTION

As noted above, data repositories used for reporting or data analysis include data warehouses and data lakes. Data warehouses tend to be proprietary in nature, and whose massively parallel processing (MPP) capabilities have transient landing/staging layers. Moreover, data warehouses comprise a permanent core layer, store very structured data, follow dimensional modeling (e.g., star/snowflake schemas), and again, are BI-oriented. Data lakes, are typically more AI-oriented, contain unstructured or semi-structured data, and are able to leverage cheap object storage.

More recently, a blend of data warehouse and data lake technologies referred to as lakehouses have emerged, and purport to offer the advantages of both traditional data lakes (cost-efficiency and flexibility regarding the manner in which data may be stored) and data warehouses (structural “discipline” and knowledge representation). However, analytical modeling techniques used in data warehouses are not ideal when based on data maintained in lakehouses, as traditional analytical modeling fails to leverage the advantages of lakehouses. Such lakehouse advantages can include, again, flexible and cost efficient data storage (cheap cloud storage) in unstructured/semi-structured form (columnar data formats, open table formats, open source querying with MPP capabilities). That is, BI modeling techniques traditionally result in normalized models for storage efficiency. However, with the aforementioned columnar table formats, for example, found with lakehouses, and with better compute/storage efficiency associated with lakehouses, normalization is unnecessary. Thus, BI models could be improved by being more denormalized, resulting in less data joins, as well as better query performance.

Moreover, traditional analytical modeling requires heavy involvement by users/data scientists with subject matter/domain expertise. For example, a dimensional modeling process may involve identifying business processes, grains, facts, and dimension tables. This results in slow modeling, and a lack of scalability/extensibility (i.e., metadata is not leveraged to assist in automating certain aspects of analytical modeling, instead relying on manual processes). Also, BI modeling is traditionally resistant to evolving, requiring data warehouses to be completely refactored when business processes change, nor is BI modeling readily adaptable to different business use cases.

It should be understood that database, table, or data normalization can refer to a technique of organizing data in a database by the application of rules that correlate data attributes with data entities. Typically, normalization is performed to eliminate redundant data, as well as to ensure that data is logically maintained/stored, where data is often segregated into distinct tables, but often involving the creation of considerable numbers of interconnections between the tables. In contrast, denormalization refers to a technique typically applied to a previously-normalized database so as to increase performance. That is, denormalization refers to a process of improving read performance of a database at the expense of degrading (to some extent, and preferably minimally) the write performance of that database by adding redundant copies of data to the database or by grouping data. For example, in denormalization, additional columns (or rows) containing data duplicated from other tables may be introduced to the database. Examples of denormalization techniques include pre-joining tables, mirroring tables, and table splitting.

Accordingly, systems and methods are directed to metadata-driven database denormalization/improved modeling. It should be noted that in the context of analytical systems, the term modeling can encompass various techniques/methods of structuring data including particular types of modeling, such as denormalization. It should also be noted that examples of the present disclosure are not limited to particular database structures. By performing denormalization/improved modeling, as set forth herein, data to be accessed/processed can be exposed to users in a manner that facilitates analytical model generation in a lakehouse data repository. That is, relevant data from a data source, e.g., one or more operational databases, can be chosen and organized for querying, which in turn, allows for an analytic model(s) to be created based on the chosen/organized data). For example, one or more operational databases may store data regarding a system's health, by way of sensor or monitored data characterizing the operation of various components of the system. The one or more operational databases can be denormalized/modeled. Extract, transform, load (ETL) (or ELT) processes may then pull the data from the one or more operational databases, transform the data, and store the transformed data in a lakehouse. An end user may then, e.g., build reports or visualizations with analytics/BI/AI software.

In particular, examples of the disclosed technology may comprise various services/service components that achieve/implement the following.

A schema analyzer service/component may analyze the schema (i.e., the logical and visual configuration) of a database, such as an operational database. As noted above, examples of the disclosed technology are directed to metadata-driven database modeling. As will be described in detail below, various denormalization/modeling techniques may be employed by examples of the disclosed technology, depending on the schema of an operational database. That is, a particular denormalization or modeling technique(s) that can be applied to/performed on data, may be better suited to a certain database schema or use-case/query. Thus, schema analysis of an operational database may result in the determination of an analytical database/lakehouse schema which can provide a basis for determining an appropriate denormalization/modeling technique to apply to the operational database.

A query statistics analyzer service/component may analyze statistics regarding lakehouse queries. While a certain database schema may lend itself to a particular type/form of denormalization or modeling, the type of queries may also have an impact on data modeling. For example, if a majority of desired or requested queries involve a need to join tables (the combination of data from multiple tables into a single results table), the result may be poor query performance. Thus, query statistics analysis can be performed to determine and generate metadata that can then be used to facilitate denormalization/modeling in accordance with examples to achieve a desired query performance. Regarding the above example, the poor query performance due to joins/aggregation of tables can be counteracted, mitigated, or otherwise addressed, making, e.g., the read time (of the database, pursuant to the queries) faster.

Further still, metadata-driven database modeling may comprise deploying transformation jobs based on various types of auto-generated/human-annotated metadata. As noted above, an enterprise or other entity may leverage one or more operational databases for transactional workloads or operations, as well as another one or more databases for analytical workloads, in this case, lakehouses. Thus, any metadata derived or generated by way of performing the aforementioned denormalization/modeling, can be used as the basis for transforming the data maintained in the one or more operational databases into the one or more lakehouses. Moreover, a user, such as a data scientist may specify certain metadata “recipes” on which transformation jobs (jobs transforming operational database data into lakehouse data) may be based. A dictionary or glossary of data mapping rules (e.g., regarding data lineage and provenance) is already maintained, and such user-defined metadata can be included in such a dictionary/glossary. Once the relevant data is obtained and structured accordingly in a lakehouse, the lakehouse can be queried for purposes of data analysis, e.g., the creation of analytic models.

Contemplated metadata-driven denormalization/modeling techniques may include path denormalization, edge denormalization, tree denormalization, and log denormalization for generating analytical data models based on the transactional data models used in the counterpart, operational/transactional database. Contemplated metadata-driven denormalization/modeling techniques may further include, e.g., state machine modeling, aggregate modeling, and adaptive denormalization. By applying such techniques to one or more operational databases, analytical data schemas for a lakehouse can be generated from the data maintained in the one or more operational databases (based on the generated metadata resulting from the performance of the denormalization/modeling), and an end user may engage in the analysis of the data in the lakehouse.

As used herein, the term metadata can refer generally to data regarding data. In the context of databases, metadata can include data referring to information about a database schema, information regarding data access, storage, built in programs or any other information about the elements of a database or usage of a database. For example, typical database metadata can include schema-related metadata, e.g., tables, columns, constraints, foreign keys, indexes, and sequences. Metadata can also include, but is not limited to: program-related metadata (e.g., user-defined functions, triggers, and views information); security-related metadata (e.g., users, user group, and privileges information); physical implementation-related metadata (e.g., partitions, files, and backup information); storage-related metadata (table sizes and indexes, and numbers of rows); and auditing-related metadata (sessions, connection and query history).

Thus, by virtue of applying the aforementioned denormalization and modeling techniques to one or more operational databases, the access/use/storage of data in the one or more operational databases is optimized for analytical model generation vis-à-vis, the resulting lakehouse. That is, the data maintained in the one or more operational databases can be transformed for use in a lakehouse, where the appropriate data is stored in a manner capable of supporting an end users' queries/analyses, i.e., a desired analytic model. The metadata generated by the aforementioned denormalization and modeling operations/techniques allows the data maintained by/in the one or more operational databases to be structured and exposed in the desired/optimal manner as a lakehouse.

Path denormalization is one type of contemplated denormalization, and can involve the schema analyzer recommending: (a) denormalizing tables for every path from root to leaf in a tree structure of the operational database; or (2) best paths to denormalize from a graph structure of an operational database (e.g., based on connected components in the graph). An edge can refer to a link/connection between two tables evidencing a relationship between the two tables. Edge denormalization can be performed to join tables at either end of an edge in a graph or tree. Alternatively, edge denormalization can be applied to combined two or more edges along a tree/graph path(s). Tree denormalization is another technique that can be performed to create a single table by combining columns from all tables of the tree structure to denormalize the entire tree.

Still another denormalization process that can be performed is log denormalization. An operational system can maintain data integrity by updating one or more related tables as part of a single transaction, where an ETL process moves data from the operational system to a data warehouse using snapshots and change data capture (CDC) events. In accordance with examples, log denormalization can form a new row for denormalized representation of data by grouping/combining all columns of any tables that participated in a transaction based on a transaction ID. As a result of such denormalization, reliance on structured data storage is avoided, while still retaining the massively parallel processing capabilities as discussed below.

Examples of the disclosed technology can also perform state machine modeling based on metadata, where a central transition table maintains an entity ID along with any other metadata that pertains to the transition and any surrounding state tables. This is in contrast to traditional modeling where a snapshot fact table is captured in a data warehouse, and lifecycles are strictly defined. Aggregate modeling is another technique that can be used, and is metadata-driven. Aggregate modeling may be performed by specifying an aggregation schema comprising any source table(s) or column(s), any desired rollup operations/formulae (time-based data aggregation that combines multiple rows with the same timestamp/dimension values), a destination table(s)/column(s) along with desired functions, such as aggregation window functions, watermarking, etc.

Adaptive denormalization/modeling can be applied whereby query patterns and statistics are monitored to track joins and aggregation-involved queries. The queries may then be parsed and analyzed, and metadata can be created for use in aggregation/join “recipes” or instructions. Thus, for example, if a query that joins tables is executed often and does so poorly, the generated metadata can be used to initiate additional denormalization jobs to improve subsequent queries.

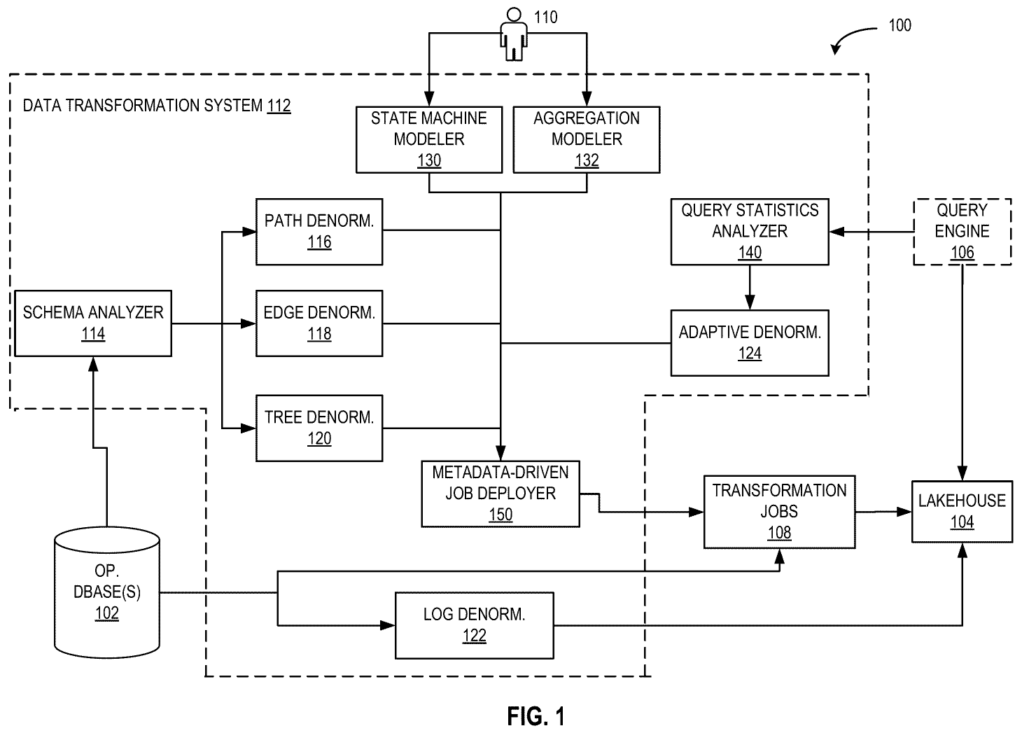

FIG. 1 illustrates the system architecture 100 of an example operational system (including operational database(s) 102), data transformation system 112, and analytical system (including lakehouse 104, query engine 106, and transformation jobs 108) in which examples of the disclosed technology may be implemented. An operational system, such as a network management system, an online retailer system, and so on, may include one or more operational databases 102. The one or more operational databases 102 may comprise data repositories configured to store or otherwise maintain data of interest (e.g., health data regarding components of example operational system 100, customer data associated with a subscription service, etc.). As noted above, the one or more operational databases 102 typically will comprise a relational database management system with atomicity, consistency, isolation, and durability (ACID) guarantees for high-performance, low-volume (fewer touching of rows) reads and writes with known transaction patterns. For example, updating customer lists/information may be a transaction performed at the one or more operational databases 102.

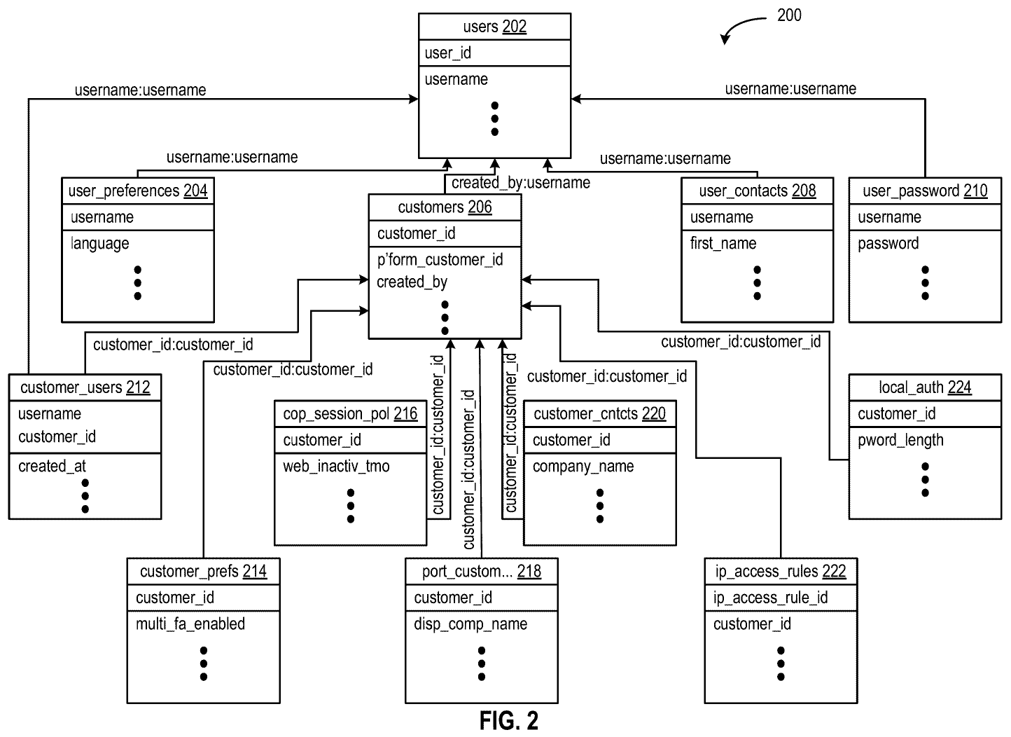

As noted above, examples of the disclosed technology leverage various denormalization and data modeling techniques to better structure data of interest in a lakehouse. Typically, data stored in the one or more operational databases 102 can be obtained and transformed into a lakehouse, e.g., lakehouse 104. An end-user (not shown), may use query engine 106 to perform queries on the data stored in lakehouse 104. Query engine 106 may, in some examples, be considered a part of lakehouse 104 (see, e.g., FIG. 2), or may be considered to be separate from lakehouse 104 (see, e.g., FIG. 1). Regardless of the location of its implementation, query engine 106 can refer to any software or interface that interacts with a data source or repository, such as lakehouse 104. Such a query engine can execute queries (requests for information) against data, such as data stored in lakehouse 104. One example query engine may be a SQL query engine that can interpret SQL commands and language to access data in a relational database. It should be noted that multiple query engines may access/interact with a particular database, and alternatively, a single query engine may be configured to query data from multiple data sources, e.g., in a single query.

As noted above, data from an operational database (such as the one or more operational databases 102), can be transformed into a desired format, e.g., for storage/use in another data repository, such as lakehouse 104. Transformation jobs 108 represent one or more operations or sets of operations intended to transform data from the one or more operational databases 102 into a format having a desired structure(s)/characteristic(s) for storage in lakehouse 104. Data transformation, as contemplated herein, can refer to one or more processes for converting, possibly cleansing, and structuring data into some useable or desired format that can be analyzed, enriching data, and so on. For example, e.g., converting data types, adding redundancy for better analytical performance (denormalizing), etc. may comprise performing ETL operations to convert data from one or more operational databases 102 into the desired format for storage in lakehouse 104. Thus, transformation jobs 108 may comprise operations or instructions to perform extraction, e.g., identifying and pulling/obtaining data from one or more operational databases 102). Transformation jobs 108 may further comprise operations or instructions to transform data, e.g., performing: data discovery to profile data (determine structure/characteristics of the data, and how the data is to be transformed); data mapping (connecting/matching data fields from one source to another); code generation and execution (for performing actual data transformation); and data review (confirming performed transformations result in desired data format/structure). It should be noted that in some instances, e.g., when lakehouse 104 is cloud-based, the transformation process may progress in an ELT fashion, whereby source data is first loaded into lakehouse 104, and transformation is performed at lakehouse 104.

As further illustrated in FIG. 1, and in accordance with examples of the disclosed technology, a data transformation system 112 may effectuate or perform various denormalization or modeling techniques to transform data from one or more operational databases 102 prior to or upon storage of that data at lakehouse 104. In some examples, data transformation system 112 may embody ETL functionality, i.e., operating as a bridge for moving data from an operational/transactional system to an analytical system, such as a lakehouse. Data transformation system 112 can be hosted, in some examples, in the cloud, on a server, etc. Again, data from one or more operational databases 102 may be normalized, but to leverage the capabilities/advantages of lakehouse 104, data transformation system 112 may selectively denormalize or model the data.

In some examples, data transformation system 112 may comprise a schema analyzer service/component 114. Schema analyzer 114 may comprise hardware, software, or a combination of both to analyze the logical configuration of one or more operational databases 102. It should be noted that, generally, information or metadata regarding schemas is readily available, e.g., PostreSQL, an example of a relational database management system provides such information via the “information schema” which comprises a set of views containing information about the objects defined in a database. Data elements or objects may be grouped and displayed as tables, functions, and relations. Thus, a schema sets forth/describes the organization and storage of the data in a database, while defining the relationship between two or more tables. Denormalizing or modeling the data from one or more operational databases 102 may be a selective process. That is, and in accordance with some examples of the disclosed technology, a particular type of denormalization or modeling may be performed/applied to the data from one or more operational databases 102. Table 1 below sets forth an example mapping of data “scenario” to suggested “approach,” i.e., transformation technique.

TABLE 1

| Scenario | Suggested Approach |
|---|---|
| Lifecycle use-case | State machine modeling |
| Frequently-visited dashboard use case | Aggregate modeling |
| Rapid evolution use-case | Adaptive denormalization |
| Deep dependency tree DB schema | Edge denormalization |
| Shallow dependency tree DB schema | Path denormalization |
| Small-size dependency tree DB schema | Tree denormalization |
| Non-tree DB schema | Log denormalization |

For example, schema analyzer 114 may initiate an “information_schema” query to identify the schema (e.g., structure) of an operational/transactional database of interest. Upon identifying the schema of one or more operational databases 102, schema analyzer 114 may trigger the performance of the suggested denormalization or modeling technique. For example, and as illustrated in FIG. 1, schema analyzer 114 may initiate the performance of one of path, edge, or tree denormalization. It should be noted that log denormalization will be discussed in greater detail below, as it need not be premised on any metadata. In accordance with the mapping set forth in Table 1, if schema analyzer 114 determines that the database schema associated with one of operational databases 102, is a tree having deep, shallow, or small-size dependency/structure, schema analyzer 114 may initiate edge, path, or tree denormalization, respectively.

Referring now to FIG. 2, an example tree database schema 200 is illustrated. Tree database schema 200 may have a table 202 representative of “users” data. It should be noted that the table 202, along with the other tables illustrated in FIG. 2, are more generally referred to as “nodes.” A next level of tree database schema 200 may include four tables, table 204 representative of “user_preferences” data, table 206, representative of “customers” data, table 208, representative of “user_contacts” data, and table 210, representative of “user_password” data. In this example, tables 204, 208, and 210 may be considered leaf tables (tables without children), while table 206 may be considered a parent table. Table 206 is a parent to the following child tables: table 212, representative of “customer_users” data); table 214, representative of “customer_preferences” data; table 216, representative of “cop-session_policy” data; table 218, representative of “portal_customization . . . ” data; table 220, representative of “customer_contacts” data,” table 222, representative of “ip_access_rules” data; and table 224, representative of “local_authentication” data. It should be noted that tree database schema 200 is only one example of a database schema, and examples of the disclosed technology are not limited to tree-based database schemas. Tables 204, 208, 210, and 212-224 may each be considered a leaf table, as none of these tables are parents to one or more child tables.

When performing edge denormalization, table joins are performed in a limited fashion, i.e., joins are performed only across adjacent levels. For example, performing edge denormalization may result in combining the columns of “users” table 202 with those of “customers” table 206. In this example, the joining of “users” table 202 with “customers” table 206 is based on a created_by field of “customers” table 206 and field “username” of “users” table 202. That is, various fields may form the link between tables. Sometimes, the linking field may be the same (as illustrated in FIG. 2 as, e.g., “username: username: or “customer_id: customer_id.” Another example of edge denormalization may be the combining of columns of “customers” table 206 with columns of “customer_preferences” table 214. In this example of edge denormalization, the common data element allowing for the combination is the “customer_id” data element. Edge denormalization may be useful when the database schema comprises a deep tree, where use-cases (e.g., queries) are not directed to access data at tree levels that are distant (e.g., greater than one level away/non-adjacent) from one another on the same root-leaf path. Thus, joins limited to adjacent-only levels of a tree will still provide/reveal relevant data.

When performing path denormalization, a denormalized table can be created for each path from a root table to each leaf table. For example, a first denormalized table can be created comprising columns combined from “users” table 202 and “user_preferences” table 204. A second denormalized table combining the columns from “users” table 202, “customers” table 206, and “customers_users” table 212 can be created. A third denormalized table combining the columns of “users” table 202, “customers” table 206, and “customer_preferences” table 214 can be created, and so on. Because the table joins that result from path denormalization encompass the tables comprising a path from a root to leaf table, path denormalization may be useful (as suggested by Table 1) when a tree database schema dependency is shallow, which limits the number/complexity of table joins while nevertheless improving, e.g., query performance.

Tree denormalization can refer to denormalizing an entire tree using relationships that exist between the tables of the tree. In some scenarios, denormalizing an entire tree can result in a large number of empty or null cells in the denormalized table. That is, when combining columns across an entire tree, the rows making up the columns from one table may not match those from another table. However, as noted above, the use of lakehouses comes with open table formats (OTFs). Typically, when transforming structured data from a relational database, e.g., the one or more operational databases 102 (FIG. 1), to an object storage, e.g., lakehouse 104, many traditional database guarantees can be lost. For example, traditional databases can provide create read update delete (CRUD) operations with guaranteed transactionality (e.g., log file records are written to some stable storage, such as a disk drive, such that if a failure occurs, the logs can be used for recovery. In contrast, object storage is immutable or unchangeable meaning any desired change/expanding of a data file involves rewriting the file. Thus, with OTFs, the data represented in the denormalized table is stored efficiently, where summary statistics and metadata, along with support data are maintained along with partition pruning (reading only relevant portions of a database based on, e.g., some filter condition) and predicate pushdown (pushing such a filter condition to the data source, such as a Parquet file.

Referring back to FIG. 1, performing any of path, edge, or tree denormalization results in the creation of metadata corresponding to the denormalization operation(s). An example of auto-generated metadata resulting from table joins performed during denormalization is set forth below. More particularly, the below would result in a joined table having those fields specified as destination_fields.

```
{
  “name”: “joined_entity”,
  “version”: “1.0”,
  “recipe_type”: “denormalization”,
  “entity_aliases”: [
    {
    “domain1.entity1”: “e1”,
    “domain1.entity2”: “e2”,
    }
  ],
  “matches”: [
    {
    “e1” : “attribute1”,
    “e2” : “attribute1”
    },
  ],
  destination_fields : [
  “e1.attribute1”,
  “e1.attribute2”,
  “e1.metric1”,
  “e2.attribute3”,
  ...
  ],
  “conditions” : [ ]
}
```

For example, based on JavaScript Object Notation (JOSN), a SQL script could be generated setting forth the following, which can be turned into an Apache Spark™ job, for example, or the script may be integrated with an infra-hosting ETL operations.

“““
SELECT
e1.attribute1,
e1.attribute2,
e1.metric1,
e2.attribute3
FROM domain1.entrity1 e1
JOIN domain1.entrity2 e2
ON e1.attribute1 = e2.attribute1
..
”””

Accordingly, metadata that is automatically generated by virtue of performing path denormalization (by path denormalization component 116), edge denormalization (by edge denormalization component 118), or tree denormalization (by tree denormalization component 120) may be fed to metadata-driven job deployer service/component 150. Metadata-driven job deployer 150 may comprise software for generating one or more scripts to effectuate the desired modeling set forth by the metadata. The transformation jobs created by metadata-driven job deployer 150 (e.g., transformation jobs 108) can then be deployed and used to transform the data from the one or more operational databases 102 for storage in lakehouse 104.

As noted above, log denormalization is another type of denormalization that may be applied to the one or more operational databases 102. An operational system such as operational system 100, typically maintains referential integrity in a database(s) by updating multiple related tables as part of a single transaction. Thus, if one table is updated with certain information, and related tables are also updated for up-to-date consistency. As also noted above, transforming data from the one or more operational databases 102 may involve ETL processes, where data is moved from the one or more operational database 102 to lakehouse 104. Regarding this move, an initial full load is performed (all data is moved), followed by CDC so that changes are known and related tables can be updated as needed. Both snapshots and CDC events contain references to some transaction ID identifying each/any table event, such as an update, if that table participated in the transaction. In accordance with various examples, a new row may be formed for a denormalized representation of a database by grouping and combining columns from tables that participated in a transaction, based on transaction ID.

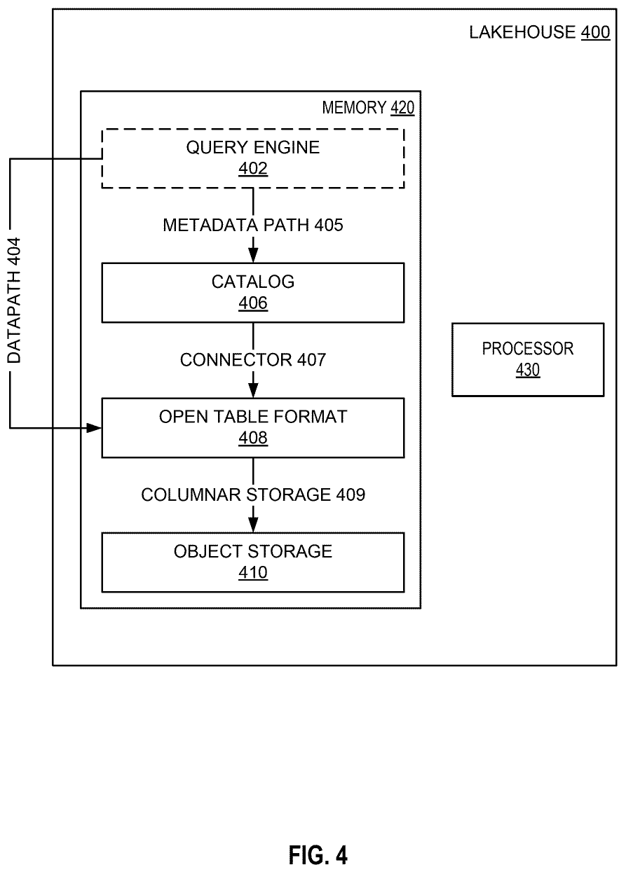

For example, and referring again to FIG. 2, the addition of a new user would result in an atomic transaction (a transaction whose nature is indivisible, i.e., it either occurs completely, or not at all). That atomic transaction would involve, e.g., inserting rows representative of the new user in both “users” table 202 and “customer_users” table 212. Columns from both tables 202 and 212 can be combined to from a single denormalized row, where grouping is based on a transaction ID associated with the addition of a new user to the database. For example, the denormalized row would comprises fields “user_id,” “username,” etc. that can be added to the “users” table 202, while the “user_count” from the “customers” table 212 (not shown) may be incremented to reflect the addition of the new user. It should be noted that log denormalization can be performed or applied at the connector level (described below with reference to FIG. 4) or at the backend (any server cluster(s)/cloud implementation of the analytical system or data transformation system beyond the operational or transactional frontend). The level at which log denormalization may be applied can depend on the trade-off between compute/network costs and a desire for establishing table-granular events for ground truth. It should also be noted that log denormalization may be performed without any prior metadata. As transactions occur at the one or more operational databases 102, log denormalizer component 122 generates corresponding lakehouse table definitions, that in conjunction with transformation jobs 108, serve to inform lakehouse 104 of the (denormalized or modeled) structure/characteristics of the data coming from the one or more operational databases 102

Still another type of denormalization that can be applied to the data of the one or more operational databases 102, is adaptive denormalization. Adaptive denormalization, may be performed by an adaptive denormalization component 124. Adaptive denormalization involves a feedback loop approach, where the query patterns and statistics regarding queries generated or set forth by query engine 106. Of interest to query statistics analyzer 140 (in the context of adaptive denormalization) are queries that involve joins and aggregations. Trino, one example of a SQL query engine that may be an example of query engine 106, comprises a ranger-audit plugin that can provide detailed visibility into executed query statements, and associated metrics/information, e.g., response time. Thus, query statistics analyzer 140 may parse and analyze query statistics made by query engine 106, and can generate metadata for aggregation and join recipes that would perform what would be deemed as processing an on-write (the creation of a schema for data before writing the data into a database). For example, such an on-write may be associated with a query that joins two tables and is executed frequently with consistently poor performance. As noted above, schema analyzer 114 may utilize a table or other mapping to perform appropriate denormalization/modeling. In some scenarios, the adaptive denormalization performed by adaptive denormalization component 124 may result in the same denormalization that would have been performed by path, edge, and/or tree denormalization (which like the other denormalization components 116-120) may also generate metadata.

Some operational systems may wish to capture the lifecycle of an entity as it moves through different phases of its life. For example, a particular device of interest may undergo various phases/states and transitions, e.g., from ordering to planning to manufacturing to shipment, claiming, and so on. Analytical systems wishing to analyze devices with varying states/that undergo transitions typically strive to provide insights into such transitions, e.g., transition statistics. In accordance with convention modeling approaches, an “accumulating snapshot fact table” may be captured, e.g, in a conventional data warehouse. However, such an approach/analysis in a data warehouse entail very strict and rigid definitions of what a lifecycle may constitute. Consider a device that may have been claimed, assigned, and subscribed to for a particular customer, but has been subsequently put back into, e.g., some factory pool to be later claimed, assigned, etc. again, and to a different customer. Traditional modeling would not capture/support such cyclical transitions.

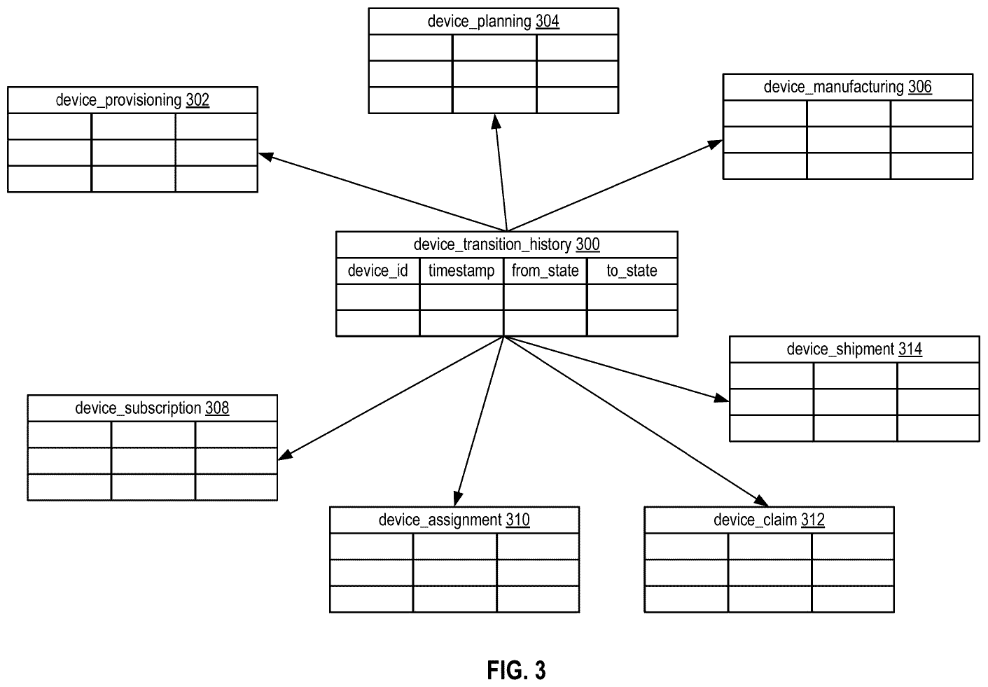

In contrast, examples of the FIG. 3 illustrates example of state machine modeling, as contemplated in accordance with examples of the disclosed technology, and as can be performed by state machine modeler 130 (FIG. 1). In particular, a metadata-driven, more generic approach may be taken, whereby a central transition table maintains relevant data along with metadata that pertains to a transition of the device from one state to another state. In the example of FIG. 3, a central “device_transition_history” table 300 maintains, e.g., device_id information, timestamp information, from_state information, and to_state information. Again, additional metadata may be captured as well. Surrounding “state” tables store device data like the device id, date in which the device exists in that particular state, as well as other metadata pertaining to the state itself (e.g., for a “shipped” state, shipping address, shipping costs, etc., would be maintained). With state modeling, rather than relying on well-defined lifecycles, examples of the disclosed technology may obtain/query data based on these generic states, and formulate a transition history that reflects the lifecycle of a device. Such states can be defined by a data engineer/scientist, for example, in a standardized JSON recipe that follows (as discussed above). Based on that specification/recipe, scripts to populate both state tables and the transition history table (based on incoming changes in the operational system) may be automatically generated. Examples of such “state” tables may include, but are not limited to the following (nor is order necessarily relevant): “device_provisioning” table 302; “device_planning” table 304; “device_manufacturing” table 306; device_subscription” table 308; “device_assignment” table 310; “device_claim” table 312; and “device_shipment” table 314.

Below is an example of metadata annotation for state modeling in accordance with examples of the disclosed technology. As can be appreciated, any conditions or rules that are to be executed to detect transitions can be specified as metadata. State tables to be updated/mapping of state table fields, and the schema of a transition table/mapping rule(s) for transition table fields from a CDC event can also be specified as metadata. In this way, an event that follows a particular “rule” or condition would result in a corresponding entry on the transition table and one or more state tables, thus providing requisite insight into a device's lifecycle. For example, when a particular device is assigned to a customer, a new row can be added to the “device_to_app_customer” table in an operational system. This assigning event can be processed to: (1) create a “CLAIMED->ASSIGNED” transition, and device_id and timestamp information can be captured in the transition table (e.g., table 300 of FIG. 3); and (2) create a row in the “device_assignment” state table with customer-is-assigned-to (“device_to_app_customer”) and timestamp information.

```
{
  “name”: “lifecycle1”,
  “recipe_type”: “state_machine”,
  “version”: “1.0”,
  “entity_aliases”: [
    {
    “domain1. device_to_app_customer”: “dtac”,
    “domain2.device_transitions”: “dt”,
    “domain2.device_claim”: “dc”,
    “domain2.device_assignement”: “da”,
    }
  ],
  “conditions” : [
    {
      “table”: “dtac”,
      “op”: “c”,
    }
  ],
  “transition” : {
    “table”: “dt”,
    “entity_id”: “dtac.device_id”,
    “from_state”: “CLAIMED”,
    “to_state: “ASSIGNED”,
    “timestamp”: “dtac.timestamp”
  },
  “states”: [
    {
      “table” : “da”,
      “device_id” : “dtac.device_id”,
      “op”: “c”
    }
  ]
```

Still another type of modeling may be performed in accordance with examples of the disclosed technology, i.e., aggregate modeling. BI dashboards are typically an integral aspect of data warehouses. Dashboard panels often depict aggregate statistics for metrics over fixed periods (hourly, daily, weekly, and the like). Aggregation on read and aggregation on write are choices that have trade-offs between acceptable query latency, query frequency, compute/storage costs, etc. However, with BI modeling, it is often recommended to have pre-populated, summarized views for better query performance for frequently-visited dashboards. In contrast, and in accordance with examples of the disclosed technology, and similar to the other denormalization/modeling techniques discussed herein, summarization and aggregation are driven by metadata.

Below is an example of metadata-driven summarization/aggregation in accordance some examples of the disclosed technology. An aggregation schema may comprise a source table(s)/column(s), desired roll-up operations/formulae (the addition of one or more levels of subtotals across some group of dimensions into query result sets with group-by clauses), a destination table(s)/column(s) with a desired aggregation window, watermarking, etc. Additionally, a generic job template can be used to operate on incoming data from an operational system to apply specified rollups in the metadata. This metadata can be specified by a user/data scientist, such as user 110 (FIG. 1), and aggregation modeling can be performed by aggregation modeler 132 as a batch job or as a streaming job.

```
{
  “name”: “entity1”,
  “version”: “1.0”,
  “type”: “record”,
  “recipe_type”: “aggregation”,
  “fields”: [
    {
    “name”: “attribute1”,
    “type”: “string”,
    “rollup”: “group-by”,
    },
    {
    “name”: “attribute2”,
    “type”: “string”,
    “rollup”: “group-by”,
    },
    {
    “name”: “metric1”,
    “type”: “double”,
    “rollup”: “avg”
    },
    {
    “name”: “metric2”,
    “type”: “double”,
    “rollup”: “avg”
    },
    {
    “name”: “timestamp”.
    “type”: “long”,
    “rollup”: “window”,
    “time-units”: “ms”,
    “interval”: “10 minute”,
    “watermark”: “30 minutes”
    }
  ]
}
```

FIG. 4 illustrates an example architecture of a lakehouse 400, which may be an example of lakehouse 104 (FIG. 1). As already discussed, query engine 402 may be some software or other interface configured to generate/execute queries on data. In some examples, query engine 400 may be implemented in/as part of lakehouse 400, but can often be implemented in the cloud/on a server remote or separate from either lakehouse 400 or an operational system, such as operational system 100. Lakehouse 400 may further comprise a processor 430 for effectuating data storage, and a memory 420 embodying the storage/database of lakehouse 400.

Based on the generated/executed queries by query engine 402, transformations can be effectuated. As described herein, transformations can involve various denormalization or modeling techniques that serve to leverage the advantages of a lakehouse (OTF, cheap, e.g., cloud-based object storage, columnar file formatting, etc.) while still maintaining, e.g., query performance typically achieved only with data warehouses. Through performance of these various denormalization/modeling techniques, metadata can be automatically generated, or users may specify/annotate metadata that can be used as bases for the transformations of data for storage in a lakehouse, such as lakehouse 400. Accordingly, a metadata path 405 is illustrated in FIG. 4, as is a data path 404.

Data path 404 can refer to the operations/movement of data from a source data repository, such as an operational database, to a target data repository, in this context, a lakehouse. Data path 404 and metadata path 405 can begin, in some scenarios, at the query engine since queries can be analyzed/statistics can be captured, and metadata can be generated therefrom. The same holds true of the data path 404 which can reflect the movement of data (from operational database to lakehouse) and its transformation from a source format/structure to that suited for a lakehouse, as well as in accordance with suggested denormalization/modeling or based on the query analysis. A catalog 406, such as a metastore, can be used to store and provide information regarding directory structure, file format, and metadata about stored data. Object storage access can be mediated through catalog 406. A user 110 (FIG. 1) may specify metadata recipes for transformation jobs, and catalog 406 can be used to store a dictionary/glossary of data mapping rules, for example.

Connector 407 can refer to services/functions that connect source data to a lakehouse, in this example the object storage 410 of lakehouse 400. Connector 407 can be used to, e.g., obtain a snapshot of source data, and the monitor and record changes to that data, e.g., a CDC connector. Depending on the desired output format, different connectors may be used, e.g., a particular open table format 408.

Object storage 410 refers to the data storage architecture typically used in lakehouses. Object storage, an example of which is Amazon S3, is geared to storing unstructured data. That is, data can be sectioned into units, also referred to as objects. The objects may then be stored in a structurally flat data format or environment. In this context, flat (flat file) can refer to a collection of data stored in a 2D database in which similar but distinct strings of information are stored as records in a table. The columns of a table can be representative of one dimension of the database, while each row is representative of a separate record

Columnar storage 409 refers to the manner in which data can be structured in the object storage 410 of lakehouse 400. In particular, when using or applying columnar storage, each data block stores or represents values of a single column for multiple rows, e.g., a column may contain the values of a specific attribute across all records. Different columnar storage formats exist, e.g., Parquet (generally known to be optimized for ready-heavy workloads and compatible with analytical tools like Apache Spark), and ORC, which tends to be more suited to write-heavy workloads and supports ACID transactions.

Open table format 408 can refer to “wrappers” that provide a layer of abstraction atop object storage 410 of lakehouse 400, allowing data to be managed/optimized in an efficient manner. In particular open table format 408 may comprise a set of files that can track schema/partition changes in a database/table, a table's data files and column statistics, as well as any inserts, updates, or deletes on a table. Examples of open table formats include Apache Iceberg, Delta Lake, and Apache Hudi.

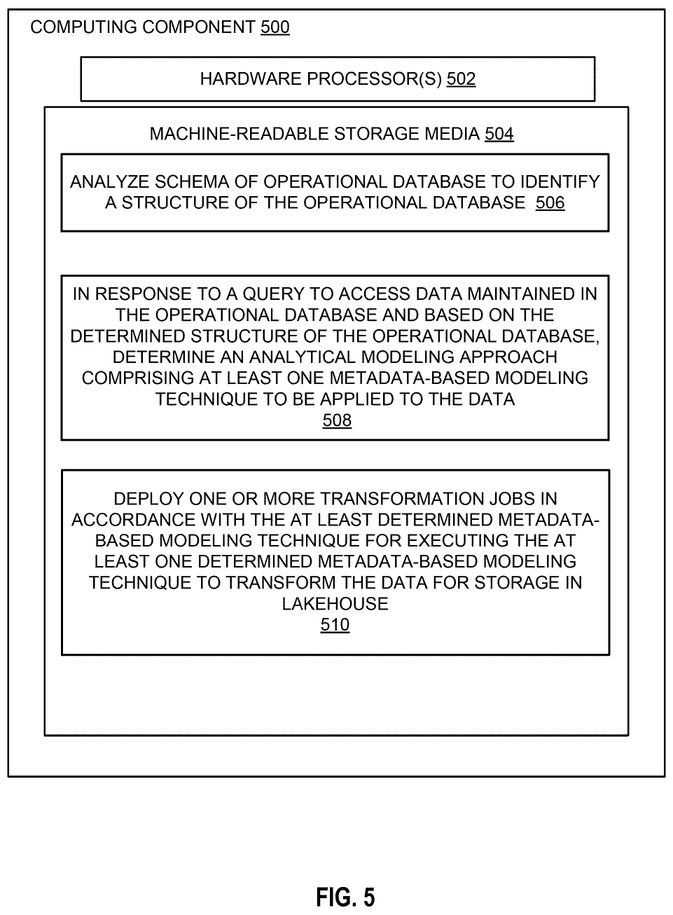

FIG. 5 illustrates an example computing component that may be used to perform metadata-driven data transformation in accordance with various embodiments. Computing component 500 may be, for example, a server computer, a controller, or any other similar computing component capable of processing data. In the example, computing component 500 includes hardware processor 502, and machine-readable storage medium 504. Computing component 500 may be an example of a data transformation system, such as data transformation system 112, an analytical system, such as that including lakehouse 104, or one or more operative components of either the data transformation or analytical systems.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-510, to control processes or operations for performing metadata-driven denormalization or modeling to transform data for use/storage in a lakehouse. As noted above, computing As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-510.

In some examples, hardware processor 502, which may be a processor of a transformation system/component of a transformation system, such as transformation system 112, may execute instruction 506 to analyze the schema of an operational database to determine the structure of the operational database. As described above, data elements or objects may be grouped and displayed as tables, functions, and relations. Thus, a schema sets forth/describes the organization and storage of the data in a database, while defining the relationship between two or more tables. In some examples, analyzing the schema of the operational database may comprise parsing/obtaining information regarding the logical and physical aspects of the schema. For example, analyzing the schema to determine structure may entail accessing and reviewing one or more files defining/characterizing the operational database in order to: determine field names, entity relationships, integrity constraints, table names (examples of logical aspects of a schema), as well as the syntax according to which data structures in the database are stored, rules data must follow, organizational details of the database, and so on (examples of physical aspects of a schema).

In some examples, hardware processor 502 may execute instruction 508 to, in response to a query to access data maintained in the operational database and based on the determined structure of the operational database, determine an analytical modeling approach comprising at least one metadata-based modeling technique to be applied to the data. As described, examples of the disclosed technology see, in part, to optimize data modeling so that the functionalities and advantages of lakehouses can be leveraged for use on data that may be stored in a non-lakehouse data repository and may be heavily structured, and likely normalized, such as the data in an operational database. Accordingly, depending on the queries on the data as well as the schema according to which the data is stored in the operational database, an appropriate denormalization or modeling approach can be taken to transform the data from the operational database to a format/structure appropriate for storage in a lakehouse, and capable of providing the desired intelligence/insight into the data. In some examples, queries from a query engine can be monitored, e.g., joins performed, query response time, etc. can be observed to determine any trends. Application of an appropriate denormalization or modeling technique may be based on such trends as well. The metadata-based aspect to the denormalization and modeling arises because once one or more appropriate denormalization/modeling technique(s) are determined, the operations or processes performed to achieve the desired denormalization/modeling automatically generates metadata characterizing that desired denormalization/modeling. As “live data” flows along the data path from the operational database to the lakehouse, the auto-generated metadata can be used to generate transformation jobs that will transform the data. In some cases, a user or data scientist may specify metadata or metadata recipes that may be used to inform or instruct the generation of the transformation jobs.

To the above, in some examples, hardware processor 502 may execute instruction 510 to deploy one or more transformation jobs in accordance with the at least one determined metadata-based modeling technique for executing the at least one determined metadata-based modeling technique to transform the data for storage in the lakehouse. Transformation jobs as described herein, may represent one or more operations or sets of operations intended to transform data from the operational database into a format having a desired structure(s)/characteristic(s) for storage in the lakehouse. Data transformation can comprise converting, possibly cleansing, and structuring data into some useable or desired format that can be analyzed, e.g., converting data types, removing duplicates (normalizing), adding redundant data (denormalizing), enriching data, and so on. For example, data transformation may encompass performing ETL operations that comprise operations or instructions to perform the following: extraction, e.g., identifying and pulling/obtaining data from the operational database; data discovery to profile the data; data mapping; code generation and execution; and data review.

In accordance with examples of the disclosed technology, the use of the aforementioned metadata-driven denormalization techniques results in relatively more denormalized analytical tables, thereby reducing the number of joins pursuant to executed queries, which in turn, results in better query performance. OTFs, made possible through the use of lakehouses improves storage efficiency by arranging data in columns, and using compression algorithms. OTFs also support OPTIMIZE (a particular type of SQL statement) operations for compacting data. Even when large amounts of data are to be scanned, techniques including, but not limited to bitmap indexing, data skipping, Z-order statistics, partition pruning, and predict pushdown result in fast queries. Thus BI modeling is made possible in a lakehouse paradigm or context. Moreover, the disclosed denormalization techniques can be applied to any database schema, allowing examples of the disclosed technology to be used to optimize various types of databases/repositories.

Other advantages can be realized through use of the disclosed technology, e.g., examples of the disclosed technology can be characterized as low-code/no-code modeling. This is because the various denormalization techniques disclosed herein use database schemas as a source to generate an analytical model, while the modeling techniques disclosed herein can use data mapping rules as metadata to generate analytical models. Adaptive denormalization/modeling generates metadata based on query audit information, while a generic metadata-driven job deployment service/functionality can refer to the generated/specified metadata to deploy data transformation jobs based on defined processing engine code for each type of metadata.

Further still, the disclosed metadata-driven approach to generic analytical modeling makes it easy to rapidly onboard new operational systems onto an analytical backend because the processing engine to interpret the metadata is already a part of the data transformation system. That said, a human entity, e.g., user/administrator, may still review any automated recommendations. For example, to onboard a database, such as a “subscription_management” database, a schema analyzer, such as that disclosed herein may analyze generated path/edge/tree denormalization metadata, and select what schema to deploy onto the lakehouse. Metadata may be annotated for purposes of state/aggregate modeling, while metadata recommendations for adaptive denormalization/modeling can be reviewed once the schema has been deployed, and the metadata is annotated. An appropriate metadata recommendation may then be chosen.

As noted above, manual intervention and oftentimes, major refactoring of analytical models occurs with traditional databases/systems when extensibility is desired pursuant to changes to an operational system's data schema. In contrast, examples of the disclosed technology can avoid such manual intervention/refactoring-instead, allowing for an already-existing analytical model to be extended by way of the disclosed denormalization and modeling. Moreover, new types of metadata recipes and processing engines for that metadata can be easily integrated into the operational system, while the adaptive denormalization/modeling results in a feedback loop mechanism to automatically create new views in the lakehouse, ensuring a better user experience . . . .

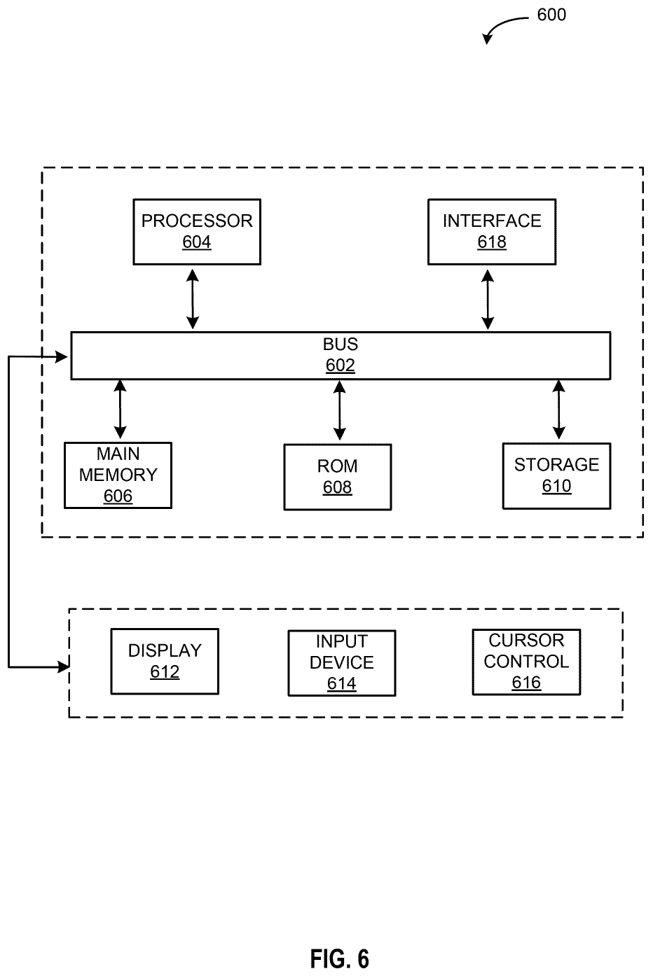

FIG. 6 depicts a block diagram of an example computer system 600 in which various examples described herein may be implemented. Computer system 600 includes bus 602 or other communication mechanism for communicating information, one or more hardware processors 604 coupled with bus 602 for processing information. Computer system 600 may be computer system embodying or executing instructions to effectuate the functionality of data transformation system 112, query engine 106, lakehouse 104, etc.

Computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes read only memory (ROM) 606 or other static storage device coupled to bus 602 for storing static information and instructions for processor 604. Storage device 610, such as a magnetic disk, optical disk, or USB thumb drive (Flash drive), etc., is provided and coupled to bus 602 for storing information and instructions.

Computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

Computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Computer system 600 also includes interface 618 coupled to bus 602. Interface 618 provides a two-way data communication coupling to one or more network links that are connected to one or more local networks. For example, interface 618 may be an integrated services digital network (ISDN) card, cable modem, satellite modem, or a modem to provide a data communication connection to a corresponding type of telephone line. As another example, interface 618 may be a local area network (LAN) card to provide a data communication connection to a compatible LAN (or WAN component to communicated with a WAN). Wireless links may also be implemented. In any such implementation, interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
analyzing, by a data transformation system operatively connected to an operational database and a lakehouse, a schema of the operational database to identify a structure of the operational database;
in response to a query to access data maintained in the operational database and based on the determined structure of the operational database, selecting, by the transformation system, an analytical modeling approach comprising at least one metadata-based modeling technique to be applied to the data; and
deploying one or more transformation jobs in accordance with the at least one determined metadata-based modeling technique for executing the at least one determined metadata-based modeling technique to transform the data for storage in the lakehouse.

2. The method of claim 1, wherein the at least one metadata-based modeling technique comprises one of state machine modeling, aggregate modeling, adaptive modeling, path denormalization, edge denormalization, tree denormalization, and log denormalization of the data at the operational database.

3. The method of claim 2, wherein the state machine modeling comprises representing the data, when the data characterizes a device's lifecycle, using a central transition table maintaining data state information and metadata pertaining to transitions of the data between states, states representing operational phases of the device.

4. The method of claim 3, wherein the state machine modeling is performed in accordance with annotated metadata comprising at least one of conditions or rules to be executed to detect the transitions of the data between the states, specified state tables to be updated, a mapping of state table fields from a continuous data capture (CDC) event occurring at the operational database, a schema of the central transition table, and one or more rules for mapping fields of the central transition table from the CDC event.

5. The method of claim 2, wherein the aggregate modeling comprises storing the data in accordance with an aggregation schema comprising at least one or more source tables or columns, one or more rollup operations or formulae, and one or more destination tables or columns with a desired aggregation window.

6. The method of claim 5, wherein a generic job template applies the one or more rollup operations or formulae to the data that is incoming from the operational database.

7. The method of claim 2, wherein the adaptive modeling comprises monitoring query patterns and statistics of queries to the lakehouse that involve at least one of joins or aggregations.

8. The method of claim 7, wherein the adaptive modeling further comprises generating metadata for at least one of a join recipe or an aggregation recipe based on the monitored query patterns and statistics.

9. The method of claim 2, wherein the path denormalization comprises creating a denormalized table for every path of the data.

10. The method of claim 2, wherein the edge denormalization comprises creating a denormalized table based on joins of linked tables.

11. The method of claim 2, wherein the tree denormalization comprises creating a denormalized table representative of all tables of the schema.

12. The method of claim 2, wherein the log denormalization comprises updating multiple related tables of the schema as part of a single transaction, and wherein an extract-transform-load operation moves the data from the operational system to the lakehouse.

13. The method of claim 12, further comprising performing CDC on the data, wherein CDC events contain a reference to a transaction identifier for a table participating in the single transaction.

14. A system, comprising:
a processor; and
a memory comprising instructions that when executed cause the processor to:
analyze a schema of the operational database, wherein the system is operative between an analytical database and the operational database;
in response to a query to access data maintained in the operational database and based on the determined structure of the operational database, determine at least one metadata-based modeling technique to be applied to the data; and
deploy one or more transformation jobs in accordance with the at least one determined metadata-based modeling technique to be executed on the data during movement of the data from the operational database to the analytical database.

15. The system of claim 14, wherein the analytical database comprises a data lakehouse.

16. The system of claim 14, wherein the at least one metadata-based modeling technique comprises one of state machine modeling, aggregate modeling, adaptive modeling, path denormalization, edge denormalization, tree denormalization, and log denormalization of the data at the operational database.

17. The system of claim 16, wherein the determination of the at least one metadata-based modeling technique depends on at least one of type of data structure used in the schema, size of the data structure used in the schema, dependencies within the data structure used in the schema, and type of analysis use-case associated with the query.

18. An analytical database, comprising:
a processor;
a memory comprising instructions that when executed cause the processor to:
receive a query to access data maintained in an operational database communicatively connected to the analytical database; and
object storage in which the data is stored after transformation of the data, the transformation of the data having been performed in accordance with transformation jobs comprising application of a metadata-based modeling technique to the data, the metadata-based modeling technique having been selected in accordance with a schema of the operational database and based on the received query to access the data.

19. The analytical database of claim 18, wherein the metadata-based modeling technique comprises one of state machine modeling, aggregate modeling, adaptive modeling, path denormalization, edge denormalization, tree denormalization, and log denormalization of the data at the operational database.

20. The analytical database of claim 16, wherein the selection of the metadata-based modeling technique depends on at least one of type of data structure used in the schema, size of the data structure used in the schema, dependencies within the data structure used in the schema, and type of analysis use-case associated with the query.
